(19) United States
(12) Patent Application Publication
(10) Pub. No.: US 2025/0313121 A1
(43) Pub. Date: Oct. 9, 2025

(54) CONTROL METHOD FOR ELECTRICALLY CHARGING A MOBILITY APPARATUS AND A MOBILITY APPARATUS PERFORMING A CHARGING PROCESS ACCORDING TO THE SAME

(71) Applicants: Hyundai Motor Company, Seoul (KR); Kia Corporation, Seoul (KR)

(72) Inventor: Won Jae LEE, Hwaseong-Si (KR)

(73) Assignees: Hyundai Motor Company, Seoul (KR); Kia Corporation, Seoul (KR)

(21) Appl. No.: 18/965,732

(22) Filed: Dec. 2, 2024

(30) Foreign Application Priority Data
Apr. 8, 2024 (KR) 10-2024-0047445

(51) Int. Cl. B60L 58/12; B60L 53/16; B60L 58/18; H02J 7/00

(52) U.S. Cl. CPC B60L 58/12; B60L 53/16; B60L 58/18; H02J 7/0036; H02J 7/00712; H02J 7/007194; B60L 2210/10

(57) ABSTRACT

A charging control method of a mobility apparatus includes identifying, by the first controller, a connection of a second high-voltage battery to the first high-voltage battery and the on-board charger through a DC/DC converter, the second high-voltage battery configured to detachably and electrically connected to the first high-voltage battery, and charging, by the first controller, at least one of the first high-voltage battery and the second high-voltage battery by controlling the on-board charger and the DC/DC converter based on information on the first high-voltage battery and the second high-voltage battery.

### CROSS-REFERENCE TO RELATED APPLICATION

The present application claims priority to Korean Patent Application No. 10-2024-0047445, filed on Apr. 8, 2024, the entire contents of which is incorporated herein for all purposes by this reference.

### BACKGROUND OF THE PRESENT DISCLOSURE

### Field of the Present Disclosure

The present disclosure relates to a charging method of a mobility apparatus driven by electricity and a mobility apparatus using the same.

### Description of Related Art

In general, an electric vehicle, a type of mobility apparatus, is operated with wheels driven by the driving force of a driving motor.

Typically, a high-voltage battery is fixedly mounted in a vehicle to supply power to a driving motor.

The driving motor may be an AC motor and an inverter may be disposed between a battery and the driving motor.

According to a charging status, which is a State of Charge (SOC), when charging is required, a battery of an electric vehicle may be charged by receiving external power through an onboard charger (OBC).

A charging time may be determined according to charging methods, including slow charging and fast charging.

With the continuous research and development on batteries, the driving distance per one charging has greatly improved recently.

However, the battery fixedly mounted in the battery of an electric vehicle may not be sufficient, and thus alternative is needed.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

The present disclosure is provided to alleviate or solve the above-described conventional problems.

Various aspects of the present disclosure are directed to providing a new concept of technology that utilizes a second high-voltage battery added to or detached from the power system of an electric vehicle when necessary in addition to a first high-voltage battery preset in the electric vehicle.

An exemplary embodiment of the present disclosure aims to determine an effective charging mode according to the specifications and status of at least one of the first high-voltage battery and the second high-voltage battery to allow charging.

According to an exemplary embodiment of the present disclosure, there is provided a charging control method of a mobility apparatus including a plurality of first wheels, at least one first driving motor for providing a driving force to the plurality of first wheels, a first high-voltage battery for providing power to the at least one driving motor, an on-board charger for performing charging with the first high-voltage battery in response to being connected to a charger, and a first controller, the method including identifying, by the first controller, a connection of a second high-voltage battery to the first high-voltage battery and the on-board charger through a DC/DC converter, the second high-voltage battery configured to detachably and electrically connected to the first high-voltage battery, and charging, by the first controller, at least one of the first high-voltage battery and the second high-voltage battery by controlling the on-board charger and the DC/DC converter based on information on the first high-voltage battery and the second high-voltage battery.

The charging may include determining a charging mode based on the information on the first high-voltage battery and the second high-voltage battery, and charging at least one of the first high-voltage battery and the second high-voltage battery by controlling the on-board charger and the DC/DC converter according to the charging mode.

The determining of the charging mode may include obtaining specifications information and status information on the first high-voltage battery and the second high-voltage battery.

The determining of the charging mode may further include determining a charging mode according to a first SOC value and a first temperature of the first high-voltage battery and a second SOC value and a second temperature of the second high-voltage battery.

The determining of the charging mode according to the first SOC value, the first temperature, the second SOC value, and the second temperature may include determining a first charging mode based on the first SOC smaller than a predetermined first reference SOC value, the second SOC smaller than a predetermined second reference SOC value, the first temperature within a predetermined first temperature range, and the second temperature within a predetermined second temperature range, determining a second charging mode based on the first SOC smaller than the first reference SOC value, the second SOC greater than the second reference SOC value, and the first temperature within the first temperature range, determining a third charging mode based on the first SOC greater than the first reference SOC value, the second SOC smaller than the second reference SOC value, and the second temperature within the second temperature range, or determining a fourth charging mode based on the first SOC greater than the first reference SOC value, the second SOC greater than the second reference SOC value, the first temperature outside the first temperature range, and the second temperature outside the second temperature range.

The first charging mode including a current charging by the on-board charger and a current charging by the DC/DC converter, the second charging mode including a current charging by the on-board charger and a voltage charging by the DC/DC converter, the third charging mode including a voltage charging by the on-board charger and a current charging by the DC/DC converter, and the fourth charging mode including a voltage charging by the on-board charger and a voltage charging by the DC/DC converter.

In the first charging mode, a discharging current of the on-board charger is determined as a smaller one between a sum of a chargeable current of the first high-voltage battery and a chargeable current of the second high-voltage battery and a dischargeable current of the on-board charger, a charging current for the first high-voltage battery is determined by subtracting a charging current for the second high-voltage battery from the discharging current of the on-board charger, and the charging current for the second high-voltage battery is determined as a smaller one between the chargeable current of the second high-voltage battery and the discharging current of the on-board charger.

In the second charging mode, a discharging current of the on-board charger is determined as a smaller one between a sum of a chargeable current of the first high-voltage battery and a chargeable current of the second high-voltage battery and a dischargeable current of the on-board charger, a charging current for the first high-voltage battery is determined as a smaller one between the chargeable current of the first high-voltage battery and the discharging current of the on-board charger, and a charging current for the second high-voltage battery is determined by subtracting the charging current for the first high-voltage battery from the discharging current of the on-board charger.

In the third charging mode, a discharging current of the on-board charger is a smaller value between a sum current of a chargeable current of the first high-voltage battery and a chargeable current of the second high-voltage battery, and a dischargeable current of the on-board charger, a charging current of the first high-voltage battery is determined by subtracting a charging current of the second high-voltage battery from the discharging current of the on-board charger, and the charging current of the second high-voltage battery is a smaller value between the chargeable current of the second high-voltage battery and the discharging current of the on-board charger.

In the fourth charging mode, a discharging current of the on-board charger is determined as a smaller one between a sum of a chargeable current of the first high-voltage battery and a chargeable current of the second high-voltage battery, and a dischargeable current of the on-board charger, the charging current for the first high-voltage battery is determined as a smaller one between the chargeable current of the first high-voltage battery and the discharging current of the on-board charger, and a charging current for the second high-voltage battery is determined by subtracting a charging current for the first high-voltage battery from the discharging current of the on-board charger.

An exemplary embodiment of the present disclosure is provided a mobility apparatus, including a plurality of wheels, at least one driving motor configured to provide a driving force to the plurality of wheels, a first high-voltage battery configured to provide power to the at least one driving motor, an on-board charger configured to perform charging the first high-voltage battery based on a connection to an external charger; and a controller including a memory configured to store computer instructions of charging control program and a processor operatively connected to the memory and configured to execute the computer instructions, wherein by executing the computer instructions, the controller is configured to identify a connection of a second high-voltage battery to the first high-voltage battery and the on-board charger through a DC/DC converter, the second high-voltage battery configured to detachably and electrically connected to the first high-voltage battery, and charge at least one of the first high-voltage battery and the second high-voltage battery by controlling the on-board charger and the DC/DC converter based on information on the first high-voltage battery and the second high-voltage battery.

The first controller may be configured to determine a charging mode according to the information on the first high-voltage battery and the second high-voltage battery, and charge at least one of the first high-voltage battery and the second high-voltage battery by controlling the on-board charger and the DC/DC converter according to the charging mode.

The controller is further configured to obtain specifications information and status information on the first high-voltage battery and the second high-voltage battery.

The controller is further configured to determine a charging mode according to a first SOC value and a first temperature of the first high-voltage battery and a second SOC value and a second temperature of the second high-voltage battery.

The controller is further configured to determine a first charging mode based on the first SOC smaller than a predetermined first reference SOC value, the second SOC smaller than a predetermined second reference SOC value, the first temperature within a predetermined first temperature range, and the second temperature within a predetermined second temperature range, determine a second charging mode based on the first SOC smaller than the first reference SOC value, the second SOC greater than the second reference SOC value, and the first temperature within the first temperature range, determine a third charging mode based on the first SOC greater than the first reference SOC value, the second SOC smaller than the second reference SOC value, and the second temperature within the second temperature range, or determine a fourth charging mode based on the first SOC greater than the first reference SOC value, the second SOC greater than the second reference SOC value, the first temperature outside the first temperature range, and the second temperature outside the second temperature range.

In at least one embodied mobility apparatus, in the first charging mode including a current charging by the on-board charger and a current charging by the DC/DC converter, the second charging mode including a current charging by the on-board charger and a voltage charging by the DC/DC converter, the third charging mode including a voltage charging by the on-board charger and a current charging by the DC/DC converter, and the fourth charging mode including a voltage charging by the on-board charger and a voltage charging by the DC/DC converter

In at least one embodied mobility apparatus, in the first charging mode, a discharging current of the on-board charger is determined as a smaller one between a sum of a chargeable current of the first high-voltage battery and a chargeable current of the second high-voltage battery and a dischargeable current of the on-board charger, a charging current for the first high-voltage battery is determined by subtracting a charging current for the second high-voltage battery from the discharging current of the on-board charger, and the charging current for the second high-voltage battery is determined as a smaller one between the chargeable current of the second high-voltage battery and the discharging current of the on-board charger.

In the second charging mode, a discharging current of the on-board charger is determined as a smaller one between a sum of a chargeable current of the first high-voltage battery and a chargeable current of the second high-voltage battery and a dischargeable current of the on-board charger, a charging current for the first high-voltage battery is determined as a smaller one between the chargeable current of the first high-voltage battery and the discharging current of the on-board charger, and a charging current for the second high-voltage battery is determined by subtracting the charging current for the first high-voltage battery from the discharging current of the on-board charger.

In the third charging mode, a discharging current of the on-board charger is a smaller value between a sum current of a chargeable current of the first high-voltage battery and a chargeable current of the second high-voltage battery, and a dischargeable current of the on-board charger, a charging current of the first high-voltage battery is determined by subtracting a charging current of the second high-voltage battery from the discharging current of the on-board charger, and the charging current of the second high-voltage battery is a smaller value between the chargeable current of the second high-voltage battery and the discharging current of the on-board charger.

In the fourth charging mode, a discharging current of the on-board charger is determined as a smaller one between a sum of a chargeable current of the first high-voltage battery and a chargeable current of the second high-voltage battery, and a dischargeable current of the on-board charger, the charging current for the first high-voltage battery is determined as a smaller one between the chargeable current of the first high-voltage battery and the discharging current of the on-board charger, and a charging current for the second high-voltage battery is determined by subtracting a charging current for the first high-voltage battery from the discharging current of the on-board charger.

The driving distance of the vehicle is extended and the usability is improved by detachably connecting to a second high-voltage battery to a power system of the electric vehicle.

According to an exemplary embodiment of the present disclosure, effective charging may be ensured by varying charging modes according to the specifications and status of a first high-voltage battery and/or a second high-voltage battery.

According to an exemplary embodiment of the present disclosure, charging time may be reduced by varying charging modes according to the specifications and status of the first high-voltage battery and/or the second high-voltage battery.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is an exemplary view exemplarily illustrating a power system of a first mobility apparatus according to an exemplary embodiment of the present disclosure;

FIG. 2 is a view exemplarily illustrating a first mobility apparatus is connected to a second mobility apparatus according to an exemplary embodiment of the present disclosure;

FIG. 3 is a flowchart illustrating a charging control method according to an exemplary embodiment of the present disclosure;

FIG. 4 is an exemplary view exemplarily illustrating specifications of a first high-voltage battery, a second high-voltage battery, a second DC/DC converter, and a charger; and

FIG. 5 is a view exemplarily illustrating a SOC-time line of a charging process according to an exemplary embodiment of the present disclosure and a comparative embodiment under the same assumption in FIG. 4.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

While embodiments are described with reference to the accompanying drawings, it should be understood that various changes and modifications may be made in an exemplary embodiment of the present disclosure. Furthermore, it should be understood that the present disclosure is not limited to the specific embodiments thereof, and various changes, equivalences, and substitutions may be made without departing from the scope and spirit of the present disclosure.

In the exemplary embodiments of the present disclosure, terms such as “module”, “unit”, “part”, and the like are terms used for nominal distinct between components, and it should not be interpreted as assuming that they are physically and chemically separated or capable of being separated or divided.

Terms including ordinal numbers, such as “first”, “second”, etc., may be used to describe various components, but the components are not limited by the terms. These terms may be used only in a nominal sense to differentiate one component from another component, and their mutual sequential meaning will be understood through the context of the corresponding description, not through such terms.

The term “and/of” is used to include all instances of any combination of multiple items being the subject. For example, “A and/or B” includes all three cases: “A”, “B”, and “A and B”.

When a component is used to be “coupled” or “connected” to another component, it will be understood that the component may be either directly connected to another component, or connected indirectly via another medium.

The terms in the present application are used to describe an exemplary embodiment and do not intend to restrict and/or limit the present disclosure. Singular forms are intended to include plural forms unless the context clearly indicates otherwise.

According to an exemplary embodiment of the present disclosure, terms such as “comprise” or “consist of” are used to designate presence of characteristics, numbers, steps, operations, elements, components or a combination thereof, and do not foreclose the presence or possibility of addition of one or more other characteristics, numbers, steps, operations, elements, components or a combination thereof.

Unless otherwise defined, all terms used in the exemplary embodiment of the present disclosure including technical or scientific terms, have the same meaning as generally understood by an ordinary person skilled in the field of the present disclosure to which the present disclosure pertains. Terms defined in commonly used dictionaries will be interpreted as having a meaning consistent with the meaning in the context of the related technology, and unless clearly defined in the present application, should not be interpreted in an ideal or excessively formal sense.

Furthermore, the terms “unit”, “control unit”, “control device”, or “controller” are only widely used for names of devices that control the corresponding functions, and are not construed as being generic functional units.

For example, devices using the terms may include a communication device that communicates with another controller or sensor to control the corresponding function, a computer-readable recording media that stores operating systems, logic commands, input/output information, etc., and at least one or more of processor that is configured to perform determination, calculation, decision, etc. used to control the corresponding function.

A processor may include a semiconductor integrated circuit and/or electronic elements that perform at least one or more of comparison, determination, calculation, and decision to achieve a programmed function. For example, the processor may be one or the combination of a computer, a microprocessor, a CPU, an ASIC, and electronic circuits (circuitry, logic circuits).

A computer-readable recording medium (or referred to as memory) includes all types of storage devices that store data that is read by a computer system. Examples of the computer-readable recording medium may include at least one a memory of flash memory type, hard disk type, micro type, and card type (e.g., Secure Digital Card (SD Card) or eXtream Digital Card (XD Card)), and a memory of Random Access Memory (RAM), Static RAM (SRAM), Read-Only Memory (ROM), Programmable ROM (PROM), Electrically Erasable PROM (EEPROM), and magnetic RAM (MRAM), a magnetic disk, and an optical disk type.

Such recording medium may be electrically connected to the processor, and the processor may load and record data from the recording medium. The recording medium and processor may be integrated or may be physically separated.

An exemplary embodiment of the present disclosure will be explained with reference to the drawings.

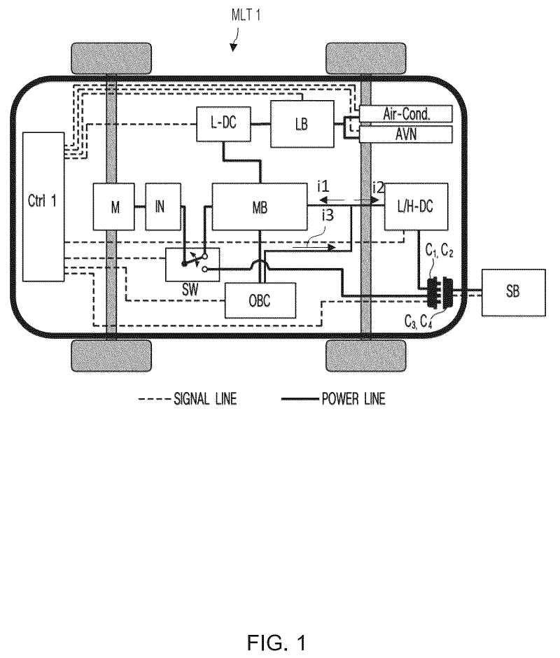

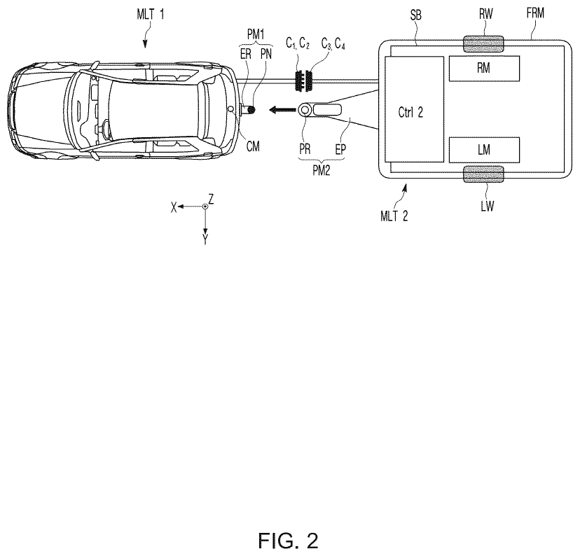

FIG. 1 is a schematic view exemplarily illustrating a power system of a first mobility apparatus MLT 1 (e.g., electric vehicle), and FIG. 2 is a view exemplarily illustrating that a second mobility apparatus MLT 2 is connected to the first mobility apparatus MLT 1.

Referring to FIG. 1 and FIG. 2, the structures of the first mobility apparatus MLT 1 and the second mobility apparatus MLT 2 will be described according to an exemplary embodiment of the present disclosure.

Referring to FIG. 1, the first mobility apparatus MLT 1 may be, for example, an electric vehicle and may include a first driving motor M, an inverter IN, a first high-voltage battery MB, an on-board charger OBC, a first DC/DC converter L-DC, a low-voltage battery LB, an air conditioning device Air-cond for operating at a low-voltage, an Audio Video Navigation (AVN), a second DC/DC converter L/H-DC, a switch SW, and a controller (referred to as a first controller).

The first driving motor M may provide a driving force to the wheels of a vehicle, for example, an alternating current motor.

The inverter IN may invert a direct current power supplied to the first driving motor M into the alternating current.

The first high-voltage battery MB may be fixedly placed in the body of the first mobility apparatus MLT 1, for example, under the bottom portion of vehicle cabin.

The first high-voltage battery MB may mainly supply electric power to the first driving motor M and may be charged with the on-board charger OBC.

The first high-voltage battery MB may be connected to a low-voltage battery LB through a first DC/DC converter L-DC to charge the low-voltage battery LB.

The first DC/DC converter may be a step-down DC/DC converter (LDC; low-voltage DC-DC converter) to charge the low-voltage battery LB.

The low-voltage battery LB may be, for example, a battery of 12V or 24V and may supply electric power to electric devices in vehicles such as an air conditioning device, an AVN, etc. That operate at low-voltage.

The second high-voltage battery SB in FIG. 1 may be placed in the second mobility apparatus MLT 2, but the present disclosure is not limited thereto. For example, the second high-voltage battery SB may be detachably placed in the first mobility apparatus MLT 1.

The second high-voltage battery SB may be electrically and removably connected to a vehicle power system including the first high-voltage battery MB in a wired method (or a wireless method within a possible range) without affecting the operation of the power system (power supply to vehicle electronics, a driving motor, etc.) as an addition.

The second high-voltage battery SB may be a replaceable battery, an auxiliary battery, an extended battery, or a secondary battery, but this is only for distinction from the first high-voltage battery MB. In other words, the second high-voltage battery SB may not be limited by the name with functions, characteristics, relationships with other objects (the first high-voltage battery MB, a host vehicle, etc.), or its own mechanical/electrical/chemical structure, battery type (types of packaging method, anode material/cathode material/separator material, etc.), charging method, etc.

The second high-voltage battery SB may be connected wirely or wirelessly with the first controller Ctrl 1 of the first mobility apparatus MLT 1, or a battery management system (BMS) of the first high-voltage battery MB, and various sensing information (e.g., voltage, current, temperature, etc.) related to the SoC state, physical/electrical/chemical status of the second high-voltage battery SB may be transmitted to the first controller Ctrl 1. However, the present disclosure is not limited thereto, but the information on the second high-voltage battery SB may be transmitted to the first controller Ctrl 1 through a second controller Ctrl 2 of the second mobility apparatus MLT 2.

According to an exemplary embodiment of the present disclosure, a high-voltage battery applied to the first high-voltage battery MB and the second high-voltage battery SB may include, for example, a plurality of battery cells that output a voltage of 2.7 to 4.2 V, and the plurality of battery cells may be connected in series/parallel to each other in a preset number to form a single module. The high-voltage battery may be packaged in one battery package with one or more battery modules connected in series/parallel to output a target output voltage, for example, approximately 400 V, 800 V, or several kV.

The first high-voltage battery MB and the second high-voltage battery SB each may include the battery management system (BMS).

The BMS may include a battery management unit (BMU), a cell monitoring unit (CMU), and a battery junction box (BJB).

The BMS may perform a cell balancing function to ensure the performance of the entire battery pack by constantly maintaining the voltage of each cell, a State of Charge (SoC) function to calculate the capacity of the entire battery system, battery cooling, charging, discharging control, etc.

The BMU may receive information on all cells from the CMU and perform the functions of the BMS based on the information.

The BMU may include, for example, two (2) micro-control units MCU, and each MCU may include a single CAN communication port. The MCU may include a CAN interface to communicate with a vehicle controller which is the upper-level device of the BMS, and a CAN interface for collecting the information of the CMU which is the lower-level device.

The CMU may be directly attached to a battery cell to perform sensing of voltage, current, temperature, etc. The CMU may not perform calculations related to BMS algorithms but may perform sensing. A plurality of battery cells may be connected to a single CMU, and information on each cell may be transmitted to the BMU through the CAN interface.

The BJB may be a pack-level detection mechanism of the BMS and a connection medium between a high-voltage battery and a drivetrain. The BJB may measure and record a battery voltage and a current flowing inside and outside the battery to accurately determine the SoC. The BJB may perform important functions to safety such as overcurrent detection, insulating monitoring, etc.

The second high-voltage battery SB may be a high-voltage battery lower than the first high-voltage battery MB, and the second DC/DC converter L/H-DC may be a step-up DC/DC converter. The second high-voltage battery SB may be a high-voltage battery higher than the first high-voltage battery MB, and the second DC/DC converter L/H-DC may be a step-down DC/DC converter. According to an exemplary embodiment of the present disclosure, the second DC/DC converter L/H-DC may be bidirectional. Therefore, the first high-voltage battery MB and the second high-voltage battery SB may charge and discharge each other.

According to an exemplary embodiment of the present disclosure, the second DC/DC converter L/H-DC may be built in the first mobility apparatus MLT 1 in the power system but the present disclosure is not limited thereto. For example, unlike an exemplary embodiment of the present disclosure, the second DC/DC converter L/H-DC may be provided as a separate component and additionally and detachably connected to the power system. The second DC/DC converter L/H-DC may be built in or detachably placed in the second mobility apparatus MLT 2.

For the detachable electrical connection of the second high-voltage battery SB to the power system, the power system of the first mobility apparatus MLT 1 may include first and second connectors C1 and C2, and the second high-voltage battery SB may include third and fourth connectors C3 and C4.

For example, the first and second connectors C1 and C2 may be connectors in an integrated form, and the third and fourth connectors C3 and C4 also may be connectors in an integrated form.

The first connector C1 may be connected to the second DC/DC converter L/H-DC, and the second connector C2 may be connected to the switch SW.

Although not shown, a signal transmission connector may be added to transmit sensing and status information on the second high-voltage battery SB to the controller.

The switch SW may be fixedly and electrically connected to the inverter IN, and switched between the first high-voltage battery MB and the second connector C2 to connect the first high-voltage battery MB to the inverter IN or electrically connect the inverter IN to the second high-voltage battery SB.

According to an exemplary embodiment of the present disclosure, the first high-voltage battery MB may be connected to the inverter IN through the switch SW, but the present disclosure is not limited thereto, and the first high-voltage battery MB may be directly connected to the inverter IN without the switch SW. In the instant case, the second connector and the fourth connector of the second high-voltage SB may not be necessary.

The first controller Ctrl 1 may be a vehicle controller of the highest level to control all electrical devices in the first mobility apparatus MLT 1, but the present disclosure is not limited thereto. For example, the first controller Ctrl 1 in FIG. 1 may be a power controller of the lower level from the vehicle controller.

According to an exemplary embodiment of the present disclosure, the first controller Ctrl 1 may include a computer-readable recording medium that stores an operating system, logic commands, input/output information, etc., and one or more processors that read the information to perform judgments, calculations, decisions, etc.

The second high-voltage battery SB in FIG. 1 may be provided in the second mobility apparatus MLT 2 as shown in FIG. 2.

The second mobility apparatus MLT 2 may include a frame FRM, a second left-wheel LW placed on the left of the frame FRM, a second right-wheel RW placed on the right of the frame FRM, a second left-driving motor LM for providing a driving force to the second left-wheel LW, a second right-driving motor RM for providing a driving force to the second right-wheel RW, and a second controller Ctrl 2.

The second high-voltage battery SB may be fixedly provided in the second mobility apparatus MLT 2, but the present disclosure is not limited thereto. The second high-voltage battery SB may be detachably placed in the second mobility apparatus MLT 2. The second high-voltage battery SB mounted in the frame FRM with a fully-discharged SoC status may be removed, and replaced with a new second high-voltage battery SB with a full-charged SoC status.

When the second high-voltage battery SB is fixedly mounted in the second mobility apparatus MLT 2, the second mobility apparatus MLT 2 may include a charging connector for charging the second high-voltage battery SB.

The frame FRM may form the exterior of the second mobility apparatus MLT 2 and accommodate other components.

The frame FRM may include a second pivot mechanism PM2 as a second connection mechanism, and the second pivot mechanism PM2 may be detachably pivot-connected to a first pivot mechanism PM1 which is a first connection mechanism fixed to the body of the first mobility apparatus MLT 1.

The first pivot mechanism PM1 may include an extension rod ER extending from the body of the first mobility apparatus MLT 1 rearwardly, and a pivot pin PN upwardly protruding from the end portion of the extension rod ER.

The second pivot mechanism PM2 may include an extension unit EP in a triangle shape, which is straightforwardly protruding from the frame FRM of the second mobility apparatus MLT 2, and a pivot ring PR into which the pivot pin PN is rotatably inserted from the end portion of the extension unit EP.

The pivot pin PN may be limited in linear movement while being inserted into the pivot ring PR, but may rotate with respect to a Z-axis direction in FIG. 2. Therefore, while being pivot-connected, the second mobility apparatus MLT 2 may be limited in linear movement with regard to the first mobility apparatus MLT 1 based on the pivot connection point, but may rotate with respect to the z-axis.

When driving in the forward direction, i.e., in the X-axis direction, the first mobility apparatus MLT 1 and the second MLT 2 may maintain straight driving without separate steering control for the second mobility apparatus MLT 2.

An exemplary embodiment of the present disclosure may include a pivot mechanism as first and second connection mechanisms, but the present disclosure is not limited thereto. For example, the first and second mechanisms may be known mechanisms that implements a non-rotational connection with respect to the Z-axis.

The second left-driving motor LM may include a rotation axis connected to the second left-wheel LW to provide a driving force to the second left-wheel LW.

The second right-driving motor RM may include a rotation axis connected to the second right-wheel RW to provide a driving force to the second right-wheel RW.

The second left-wheel LW and the second right-wheel RW may be respectively connected to the second left-driving motor LM and the second right-driving motor RM, enabling independent driving from each other.

The second left-driving motor LM and the second right-driving motor RM may drive in the forward direction and in the reverse direction, respectively. When driven in the forward direction, the second mobility apparatus MLT 2 may travel in the forward direction, and when driven in the reverse direction, the second mobility apparatus MLT 2 may travel in the rear direction.

For example, the second left-driving motor LM and the second right-driving motor RM each may be implemented in an in-wheel driving system where each driving motor is provided in wheels, but the present disclosure is not limited thereto.

Unlike an exemplary embodiment of the present disclosure, the second mobility apparatus MLT 2 may not operate independently on the left and right, but the driving force of a single common motor may be delivered into the second left-wheel LW and the second right-wheel RW. For this, a vehicle gear may be included between the common second driving motor, the second left-wheel LW, and the second right-wheel RW. The driving force of the second driving motor may be divided by the vehicle gear and transmitted to the second left-wheel LW and the second right-wheel RW. A toque vectoring means may be added for torque distribution between the second left-wheel LW and the second right-wheel RW.

Referring to FIG. 2, the second controller Ctrl 2 may be configured for controlling the second left-driving motor LM and the second right-driving motor RM to achieve forward driving and reverse driving of the second mobility apparatus MLT 2. The second controller Ctrl 2, when the steering of the second mobility apparatus MLT 2 is needed, may change the driving direction of the second mobility apparatus MLT 2 by controlling respective toques or the rotation numbers of the second left-driving motor LM and the second right-driving motor RM. Through the independent control of driving of the second left-driving motor LM and the second right-driving motor RM, the steering of the second mobility apparatus MLT 2 may be ensured without a separate steering device.

Wired and wireless communication means may be included to deliver information between connectors in FIG. 1, the first mobility apparatus MLT 1, and the second mobility apparatus MLT 2.

According to an exemplary embodiment of the present disclosure, the first controller Ctrl 1 or the second controller Ctrl 2 may include a memory and a processor. The memory may store computer commanders for performing the functions of the controller, and the processor is configured to perform the functions by loading and executing the commands from the memory.

The memory may include at least one of Hard Disk Drive (HDD), Solid-State Drive (SDD), Silicon Disk Drive (SDD), ROM, RAM, CD-ROM, magnetic tape, floppy disk, and optical data storage device.

The processor may include at least one of a computer, a microprocessor, a central processing unit (CPU), an ASIC, an electric circuit, and a logic circuit.

The first connector C1 and the second connector C2 of the first mobility apparatus MLT 1 may be connected to the third connector C3 and the fourth connector C4 of the second mobility apparatus MLT 2. As a signal transmission connector is connected, the first mobility apparatus MLT 1 and the second mobility apparatus MLT 2, i.e., the first controller Ctrl 1 and the second controller Ctrl 2 may communicate with each other.

When the first mobility apparatus MLT 1 and the second mobility apparatus MLT 2 are mechanically and electrically connected, and the first mobility apparatus MLT 1 starts the forward driving, the second controller Ctrl 2 may perform the straightforward driving of the second mobility apparatus MLT 2 by controlling the second left-driving motor LM and the second right-driving motor RM according to the signal received from the first connector C1.

Part or all of the speed, gear position, steering angle, accelerator pedal sensor (APS) information, and brake pedal sensor (BPS) information of the first mobility apparatus MLT 1 may be transmitted to the second mobility apparatus MLT 2.

The second controller Ctrl 2 of the second mobility apparatus MLT 2 may be configured to determine whether the first mobility apparatus MLT 1 operates in the forward direction or in the reverse direction by use of part or all of the speed, the gear position, the APS information, and the BPS information of the first mobility apparatus MLT 1. However, the present disclosure is not limited thereto, but it may be possible to directly receive information on whether the first mobility apparatus operates in the forward direction or in the reverse direction from the first controller Ctrl 1.

When the first mobility apparatus MLT 1 operates in the straightforward direction, the second controller Ctrl 2 may perform the straightforward driving of the second mobility apparatus MLT 2 by operating the second left driving motor LM and the second right driving motor RM in the forward direction. When the first mobility apparatus MLT 1 operates in the rear direction, the second controller Ctrl 2 may perform the rear driving of the second mobility apparatus MLT 2 by operating the second left driving motor LM and the second right driving motor RM in the reverse direction.

When the first mobility apparatus MLT 1 operates in the forward direction, the second controller Ctrl 2 may drive the second left-driving motor LM and the second right-driving motor RM in the forward direction to allow the second mobility apparatus MLT 2 to operate in the straightforward direction. When the first mobility apparatus MLT 1 operates in the reverse direction, the second controller Ctrl 2 may drive the second left-driving motor LM and the second right-driving motor RM in the reverse direction to allow the rear-driving of the second mobility apparatus MLT 2.

The second controller Ctrl 2 may be configured to determine the steering status based on steering angle information on the first mobility apparatus MLT 1 and perform the steering of the second mobility apparatus MLT 2 accordingly.

The second mobility apparatus MLT 2 may not include a separate steering device such as a steering wheel, a steering rack, etc., but may perform the steering through torque control of the second left-driving motor LM and second right-driving motor RM.

The second controller Ctrl 2 may be configured to determine a driving torque for driving and a steering torque for steering for each of the second left-driving motor LM and the second right-driving motor RM to use for control.

For example, for the steering of the second mobility apparatus MLT 2, the steering torque value of the second left-driving motor LM and the second right-driving motor RM according to the steering angle of the first mobility apparatus MLT 1 may be included in a lookup table or a calculation program.

While driving in a straightforward direction, the speed of the second mobility apparatus MLT 2 may be controlled not to exceed the speed of the first mobility apparatus MLT 1. The pivot connection between the first mobility apparatus MLT 1 and the second mobility apparatus MLT 2 may be within a predetermined pivot angle. For example, while driving in the straightforward direction, when the speed of the second mobility apparatus MLT 2 is equal to or smaller than the speed of the first mobility apparatus MLT 1, the pivot angle of the second mobility apparatus MLT 2 with respect to the first mobility apparatus MLT 1 from the pivot connection point may be 0 degrees (an angle at which the first mobility apparatus MLT 1 and the second mobility apparatus MLT 2 are in a straight line).

While driving in the forward direction, the second mobility apparatus MLT 2 may be controlled to follow the first mobility apparatus MLT 1, achieving continued and smooth driving of a plurality of mobilities.

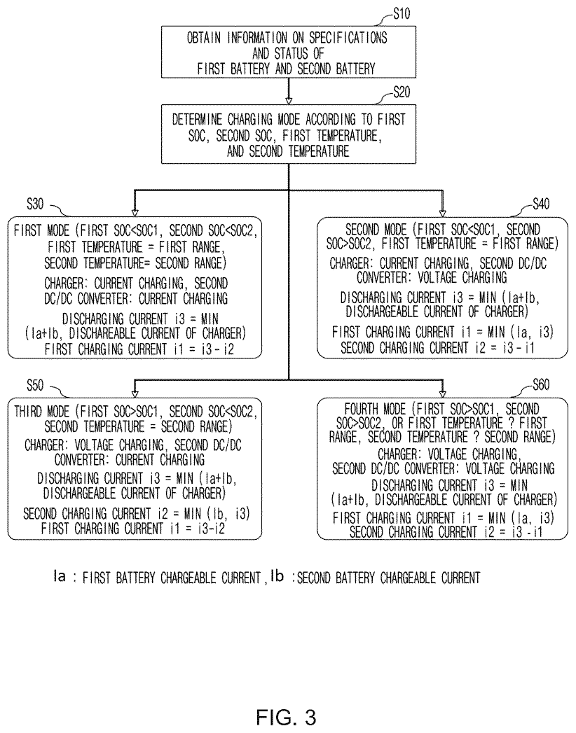

FIG. 3 is a view exemplarily illustrating a charging control method according to an exemplary embodiment of the present disclosure, and the description thereof will be detailed below.

The flowchart in FIG. 3 illustrates under the assumption that when the second high-voltage battery SB is electrically connected to the first high-voltage battery MB and the on-board charger OBC through the second DC/DC converter L/H-DC as shown in FIG. 1, the first mobility apparatus MLT 1 in FIG. 1 is electrically connected to the on-board charger OBC while an external charger is plugged in.

As the on-board charger is plugged in, the first controller Ctrl 1 may perform the charging process in FIG. 3 by controlling the on-board charger OBC and the second DC/DC converter L/H-DC.

The first controller Ctrl 1 may obtain specifications and status information on the first high-voltage battery MB and the second high-voltage battery SB at step S10.

The information may be transmitted from the BMS of the first high-voltage battery MB and the BMS of the second high-voltage battery SB. The specification information on the battery may be information pre-stored in the memory.

The battery specifications may include at least one of a current rate (C-rate), a nominal voltage, an efficiency, a maximum current, a system voltage, and a continuous output, and the battery status information may include at least one of a State of Health (SOH), an SOC value, a voltage, a temperature, etc.

The first controller Ctrl 1 may identify a current SOC (referred to as ‘first SOC’) and a current temperature (referred to as ‘first temperature’) of the first high-voltage battery MB, and a current SOC (referred to as ‘second SOC’) and a current temperature (referred to as ‘second temperature’) of the second high-voltage battery SB, and determine a charging mode accordingly. The information of the SOCs and the temperatures of the first and second high-voltage batteries may be obtained by the respective BMSs sending them to the first controller Ctrl 1.

When it is determined that the first SOC is smaller than a predetermined first reference SOC (SOC1), the second SOC is smaller than a predetermined second reference SOC (SOC2), the first temperature is within a predetermined first temperature range, and the second temperature is within a predetermined second temperature range, the first controller Ctrl 1 may be configured to determine the charging mode as a first charging mode.

According to the determination, the first controller Ctrl may perform charging according to the first charging mode at step S30.

In the first charging mode, the charging method of the on-board charger may be current charging, and the charging method of the second DC/DC converter L/H-DC may be current charging. The current charging may be the charging by current control, e.g., constant current charging.

In the first charging mode, the first controller Ctrl 1 may be configured to determine the discharging current of the on-board charger, i.e., an output current i3 of the on-board charger OBC may be a smaller value between a sum current of a chargeable current (i.e., maximum current) Ia of the first high-voltage battery MB and a chargeable current (i.e., maximum current) Ib of the second high-voltage battery SB, and a dischargeable current of the on-board charger. A charging current i1 for the first high-voltage battery MB may be determined by subtracting a charging current i2 for the second high-voltage battery SB from the discharging current i3 of the on-board charger. The charging current i2 for the second high-voltage battery SB may be a smaller value between the chargeable current Ib of the second high-voltage battery SB and a discharging current i3 of the on-board charger.

The dischargeable current of the on-board charger may be information received from a charging station or an external server through data communication.

The first controller Ctrl 1 may be configured to determine a charging mode as a second charging mode when the first SOC is smaller than the SOC1, the second SOC is greater than the SOC2, and the first temperature is within the first temperature range.

The first controller Ctrl 1 may perform the second charging mode at step S40, The charging method of the on-board charger may be the current charging, and the charging method of the second DC/DC converter L/H-DC may be voltage charging. The voltage charging may be the charging by voltage control, e.g., constant current charging.

In the second charging mode, the first controller Ctrl 1 may be configured to determine the discharging current i3 of the on-board charger as a smaller value between the sum current of the chargeable current Ia of the first high-voltage battery MB and the chargeable current Ib of the second high-voltage battery SB, and the discharging current i3 of the on-board charger. The charging current i1 for the first high-voltage battery MB may be a smaller value between the chargeable current Ia of the first high-voltage battery MB and the discharging current i3 of the on-board charger. The charging current i2 for the second high-voltage battery SB may be determined by subtracting the charging current i1 for the first high-voltage battery MB from the discharging current i3 of the on-board charger.

The controller Ctrl 1 may be configured to determine the charging mode as a third charging mode when the first SOC is greater than the SOC1, the second SOC is smaller than the SOC2, and the second temperature is within a second temperature range.

The first controller Ctrl 1 may perform the third charging mode at step S50, the charging method of the on-board charger may be the voltage charging, and the charging method of the second DC/DC converter L/H-DC may be the current charging.

In the third charging mode, the first controller Ctrl 1 may be configured to determine the discharging current i3 of the on-board charger as a smaller value between the sum current of the chargeable current Ia of the first high-voltage battery MB and the chargeable current Ib of the second high-voltage battery SB, and the dischargeable current i3 of the on-board charger. The charging current i1 for the first high-voltage battery MB may be determined by subtracting the charging current i2 for the second high-voltage battery SB from the discharging current i3 of the on-board charger, and the charging current i2 for the second high-voltage battery SB may be determined by a smaller value between the chargeable current Ib of the second high-voltage battery SB and the discharging current i3 of the on-board charger.

The first controller Ctrl 1 may be configured to determine the charging mode as a fourth charging mode when the first SOC is greater than the SOC1, the second SOC is greater than the SOC2, the first temperature is outside the first temperature range, and the second temperature is outside the second temperature range.

The first controller Ctrl 1 may perform the fourth charging mode at step S60. The charging method of the on-board charger may be the voltage charging, and the charging method of the second DC/DC converter L/H-DC may be the voltage charging.

In the fourth charging mode, the first controller Ctrl 1 may be configured to determine the discharging current i3 of the on-board charger as a smaller value between the sum current of the chargeable current Ia of the first high-voltage battery MB and the chargeable current Ib of the second high-voltage battery SB, and the dischargeable current of the on-board charger. The charging current i2 for the second high-voltage battery SB may be determined by subtracting the charging current i1 for the first high-voltage battery MB from the discharging current i3 of the on-board charger. The charging current i1 for the first high-voltage battery MB may be determined as a smaller value between the chargeable current Ia of the first high-voltage battery MB and the discharging current i3 of the on-board charger.

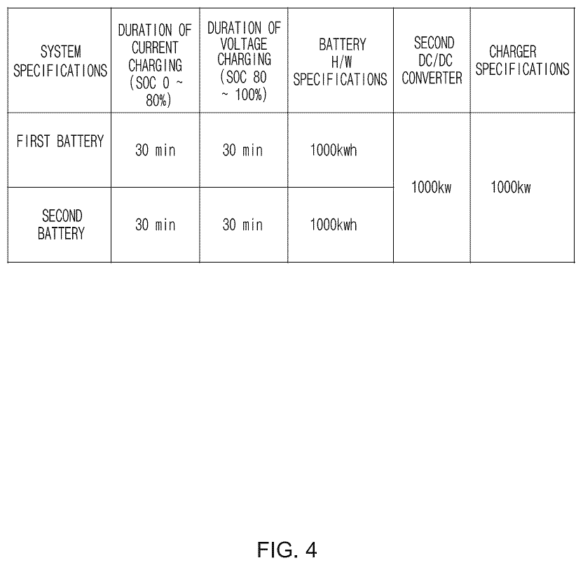

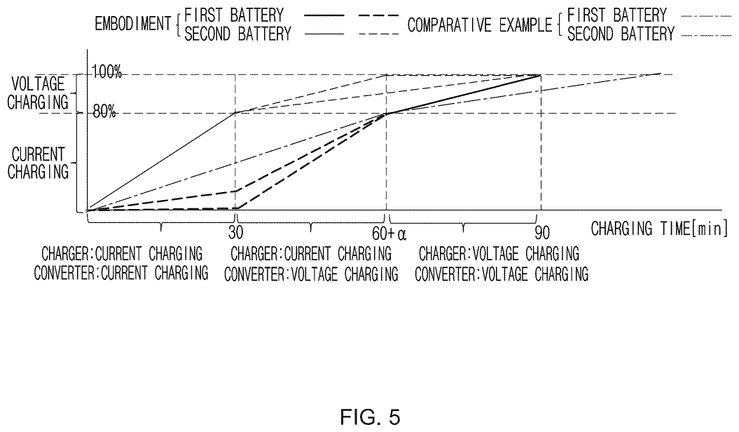

Referring to FIG. 4 and FIG. 5, the charging result according to an exemplary embodiment of the present disclosure will be described in comparison with the result of a comparative example.

FIG. 4 is an exemplary view exemplarily illustrating the specifications of the first high-voltage battery MB, the second high-voltage battery SB, the second DC/DC converter L/H-DC, and the on-board charger under the assumption. FIG. 5 illustrates a SOC-time line of a charging process of an exemplary embodiment of the present disclosure and a comparative example under the same assumption as FIG. 4.

Referring to FIG. 4, under the assumption, it may take 30 minutes for the first high-voltage battery MB and the second high-voltage battery SB each to reach 80% of the SoC during current charging, it may take 30 minutes for the first high-voltage battery MB and the second high-voltage battery SB each to reach from 80% to 100% during voltage charging, and the maximum charging current may be 1000 kwh.

Furthermore, it is assumed that the maximum current of the second DC/DC converter L/H-DC and the on-board charger is 1000 kwh.

It is assumed that the SOC1 and the SOC2 are 80% respectively.

During charging, as shown in FIG. 5, the on-board charger and the second DC/DC converter L/H-DC may be controlled by current charging during the first 30 minutes, and the SOC value of the second high-voltage battery SB may reach 80%.

After 30 minutes, for 60+a minutes, the on-board charger may be controlled by current charging, the second DC/DC converter L/H-DC may be controlled by voltage charging, and the SOC value of the first high-voltage battery MB may reach 80%.

The charging of the first high-voltage battery MB may proceed in various profiles (thick dotted lines) depending on the maximum chargeable amount of the first high-voltage battery MB and the maximum dischargeable amount of the on-board charger.

The charging of the second high-voltage battery SB may reach SOC 100% for a time period from 30 minutes to 90 minutes after the start of charging by the second DC/DC converter L/H-DC controlled by voltage charging.

The charging of the second high-voltage battery SB during the time period from 30 minutes to 90 minutes after the start of charging may proceed in various profiles (thin dotted line) depending on the maximum chargeable amount of the second high-voltage battery SB and the maximum dischargeable amount of the on-board charger.

The first high-voltage battery MB may be charged to SOC 100% through the on-board charger controlled by voltage charging for the time period from 60+a minutes to 90 minutes.

According to an exemplary embodiment of the present disclosure, charging of the first high-voltage battery MB and the second high-voltage battery SB may be completed for 90 minutes after the start of charging.

However, according to a comparative example, unlike an exemplary embodiment of the present disclosure, charging may be performed in a single mode.

In the comparative example, as indicated by the dashed-dotted line in FIG. 5, the first high-voltage battery MB and the second high-voltage battery SB both may reach SOC 80% in 60+α minutes through current charging control, and reach SOC 100% according to voltage charging control.

As shown in FIG. 5, the charging according to an exemplary embodiment of the present disclosure may take less charging time than the comparative example.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well-known to a person including ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, a plurality of operations may be merged, or any operation may be divided, and a predetermined operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A charging control method of a mobility apparatus including a plurality of wheels, at least one driving motor for providing a driving force to the plurality of wheels, a first high-voltage battery for providing power to the at least one driving motor, an on-board charger for performing charging the first high-voltage battery based on a connection to an external charger, and a controller, the method comprising:
identifying, by the controller, a connection of a second high-voltage battery to the first high-voltage battery and the on-board charger through a DC/DC converter, the second high-voltage battery configured to detachably and electrically connected to the first high-voltage battery; and
charging, by the controller, at least one of the first high-voltage battery and the second high-voltage battery by controlling the on-board charger and the DC/DC converter based on information on the first high-voltage battery and the second high-voltage battery.

2. The method of claim 1, wherein the charging includes:
determining, by the controller, a charging mode based on the information on the first high-voltage battery and the second high-voltage battery, and
charging, by the controller, the at least one of the first high-voltage battery and the second high-voltage battery by controlling the on-board charger and the DC/DC converter according to the charging mode.

3. The method of claim 2, wherein the determining of the charging mode includes obtaining the information including specifications information and status information on the first high-voltage battery and the second high-voltage battery.

4. The method of claim 3, wherein the determining of the charging mode further includes determining the charging mode according to a first SOC value and a first temperature of the first high-voltage battery and a second SOC value and a second temperature of the second high-voltage battery.

5. The method of claim 4,
wherein the charging mode includes a first charging mode, a second charging mode, a third charging mode and a fourth charging mode, and
wherein the determining of the charging mode according to the first SOC value, the first temperature, the second SOC value, and the second temperature includes:
determining the first charging mode based on the first SOC smaller than a predetermined first reference SOC value, the second SOC smaller than a predetermined second reference SOC value, the first temperature within a predetermined first temperature range, and the second temperature within a predetermined second temperature range;
determining the second charging mode based on the first SOC smaller than the first reference SOC value, the second SOC greater than the second reference SOC value, and the first temperature within the first temperature range;
determining the third charging mode based on the first SOC greater than the first reference SOC value, the second SOC smaller than the second reference SOC value, and the second temperature within the second temperature range; or
determining the fourth charging mode based on the first SOC greater than the first reference SOC value, the second SOC greater than the second reference SOC value, the first temperature outside the first temperature range, and the second temperature outside the second temperature range.

6. The method of claim 5,
wherein the first charging mode including a current charging by the on-board charger and a current charging by the DC/DC converter,
wherein the second charging mode including a current charging by the on-board charger and a voltage charging by the DC/DC converter,
wherein the third charging mode including a voltage charging by the on-board charger and a current charging by the DC/DC converter, and
wherein the fourth charging mode including a voltage charging by the on-board charger and a voltage charging by the DC/DC converter.

7. The method of claim 6, wherein in the first charging mode,
a discharging current of the on-board charger is determined as a smaller one between a sum of a chargeable current of the first high-voltage battery and a chargeable current of the second high-voltage battery and a dischargeable current of the on-board charger,
a charging current for the first high-voltage battery is determined by subtracting a charging current for the second high-voltage battery from the discharging current of the on-board charger, and
the charging current for the second high-voltage battery is determined as a smaller one between the chargeable current of the second high-voltage battery and the discharging current of the on-board charger.

8. The method of claim 6, wherein in the second charging mode,
a discharging current of the on-board charger is determined as a smaller one between a sum of a chargeable current of the first high-voltage battery and a chargeable current of the second high-voltage battery and a dischargeable current of the on-board charger,
a charging current for the first high-voltage battery is determined as a smaller one between the chargeable current of the first high-voltage battery and the discharging current of the on-board charger, and
a charging current for the second high-voltage battery is determined by subtracting the charging current for the first high-voltage battery from the discharging current of the on-board charger.

9. The method of claim 6, wherein in the third charging mode,
a discharging current of the on-board charger is a smaller value between a sum current of a chargeable current of the first high-voltage battery and a chargeable current of the second high-voltage battery, and a dischargeable current of the on-board charger,
a charging current of the first high-voltage battery is determined by subtracting a charging current of the second high-voltage battery from the discharging current of the on-board charger, and
the charging current of the second high-voltage battery is a smaller value between the chargeable current of the second high-voltage battery and the discharging current of the on-board charger.

10. The method of claim 6, wherein in the fourth charging mode,
a discharging current of the on-board charger is determined as a smaller one between a sum of a chargeable current of the first high-voltage battery and a chargeable current of the second high-voltage battery, and a dischargeable current of the on-board charger,
the charging current for the first high-voltage battery is determined as a smaller one between the chargeable current of the first high-voltage battery and the discharging current of the on-board charger, and
a charging current for the second high-voltage battery is determined by subtracting a charging current for the first high-voltage battery from the discharging current of the on-board charger.

11. A mobility apparatus, comprising:
a plurality of wheels;
at least one driving motor configured to provide a driving force to the plurality of wheels;
a first high-voltage battery configured to provide power to the at least one driving motor;
an on-board charger configured to perform charging the first high-voltage battery based on a connection to an external charger; and
a controller including a memory configured to store computer instructions of charging control program and a processor operatively connected to the memory and configured to execute the computer instructions,
wherein by executing the computer instructions, the controller is configured to identify a connection of a second high-voltage battery to the first high-voltage battery and the on-board charger through a DC/DC converter, the second high-voltage battery configured to detachably and electrically connected to the first high-voltage battery, and charge at least one of the first high-voltage battery and the second high-voltage battery by controlling the on-board charger and the DC/DC converter based on information on the first high-voltage battery and the second high-voltage battery.

12. The mobility apparatus of claim 11, wherein the controller is further configured to:
determine a charging mode according to the information on the first high-voltage battery and the second high-voltage battery; and
charge the at least one of the first high-voltage battery and the second high-voltage battery by controlling the on-board charger and the DC/DC converter according to the charging mode.

13. The mobility apparatus of claim 12, wherein the controller is further configured to obtain the information including specifications information and status information on the first high-voltage battery and the second high-voltage battery.

14. The mobility apparatus of claim 13, wherein the controller is further configured to determine the charging mode according to a first SOC value and a first temperature of the first high-voltage battery and a second SOC value and a second temperature of the second high-voltage battery.

15. The mobility apparatus of claim 14,
wherein the charging mode includes a first charging mode, a second charging mode, a third charging mode and a fourth charging mode, and
wherein the controller is further configured to:
determine the first charging mode based on the first SOC smaller than a predetermined first reference SOC value, the second SOC smaller than a predetermined second reference SOC value, the first temperature within a predetermined first temperature range, and the second temperature within a predetermined second temperature range,
determine the second charging mode based on the first SOC smaller than the first reference SOC value, the second SOC greater than the second reference SOC value, and the first temperature within the first temperature range,
determine the third charging mode based on the first SOC greater than the first reference SOC value, the second SOC smaller than the second reference SOC value, and the second temperature within the second temperature range, or determine the fourth charging mode based on the first SOC greater than the first reference SOC value, the second SOC greater than the second reference SOC value, the first temperature outside the first temperature range, and the second temperature outside the second temperature range.

16. The mobility apparatus of claim 15,
wherein the first charging mode includes a current charging by the on-board charger and a current charging by the DC/DC converter,
wherein the second charging mode including a current charging by the on-board charger and a voltage charging by the DC/DC converter,
wherein the third charging mode includes a voltage charging by the on-board charger and a current charging by the DC/DC converter, and
wherein the fourth charging mode includes a voltage charging by the on-board charger and a voltage charging by the DC/DC converter.

17. The mobility apparatus of claim 16, wherein in the first charging mode,
a discharging current of the on-board charger is determined as a smaller one between a sum of a chargeable current of the first high-voltage battery and a chargeable current of the second high-voltage battery and a dischargeable current of the on-board charger,
a charging current for the first high-voltage battery is determined by subtracting a charging current for the second high-voltage battery from the discharging current of the on-board charger, and
the charging current for the second high-voltage battery is determined as a smaller one between the chargeable current of the second high-voltage battery and the discharging current of the on-board charger.

18. The mobility apparatus of claim 16, wherein in the second charging mode,
a discharging current of the on-board charger is determined as a smaller one between a sum of a chargeable current of the first high-voltage battery and a chargeable current of the second high-voltage battery and a dischargeable current of the on-board charger,
a charging current for the first high-voltage battery is determined as a smaller one between the chargeable current of the first high-voltage battery and the discharging current of the on-board charger, and
a charging current for the second high-voltage battery is determined by subtracting the charging current for the first high-voltage battery from the discharging current of the on-board charger.

19. The mobility apparatus of claim 16, wherein in the third charging mode,
a discharging current of the on-board charger is a smaller value between a sum current of a chargeable current of the first high-voltage battery and a chargeable current of the second high-voltage battery, and a dischargeable current of the on-board charger,
a charging current of the first high-voltage battery is determined by subtracting a charging current of the second high-voltage battery from the discharging current of the on-board charger, and
the charging current of the second high-voltage battery is a smaller value between the chargeable current of the second high-voltage battery and the discharging current of the on-board charger.

20. The mobility apparatus of claim 16, wherein in the fourth charging mode,
a discharging current of the on-board charger is determined as a smaller one between a sum of a chargeable current of the first high-voltage battery and a chargeable current of the second high-voltage battery, and a dischargeable current of the on-board charger,
the charging current for the first high-voltage battery is determined as a smaller one between the chargeable current of the first high-voltage battery and the discharging current of the on-board charger, and
a charging current for the second high-voltage battery is determined by subtracting a charging current for the first high-voltage battery from the discharging current of the on-board charger.
